(19) United States
(12) Patent Application Publication
(10) Pub. No.: US 2018/0053939 A1
(43) Pub. Date: Feb. 22, 2018

(54) USE OF A LIQUID COMPOSITION OF CARBON-BASED NANOFILLERS FOR LEAD BATTERY ELECTRODE FORMULATIONS

(71) Applicants: Arkema France, Colombes (FR); Vulcan Automotive Industries Ltd., Yavne (IL)

(72) Inventors: Alexander KORZHENKO, Pau (FR); Christophe VINCENDEAU, Lons (FR); Patrick DELPRAT, Lescar (FR); Beni CAHANA, Yokneam (IL)

(21) Appl. No.: 15/554,263

(22) PCT Filed: Mar. 4, 2016
(86) PCT No.: PCT/EP2016/000384

§ 371 Date: Aug. 29, 2017

(30) Foreign Application Priority Data
Mar. 5, 2015 (FR) 1551844

(51) Int. Cl. H01M 4/62

(52) U.S. Cl. CPC H01M 4/625; B82Y 30/00; H01M 4/622

(57) ABSTRACT

The present invention relates to the field of lead batteries.

More particularly, the present invention relates to the use, in the preparation of a lead battery electrode formulation, of a liquid composition, stable over time, comprising from 0.2% to 10% by weight, preferably from 0.2% to 5% by weight, of carbon-based nanofillers, at least one water-soluble polymer and at least one cationic component chosen from alkali metal or alkaline earth metal cations and ammonium ions dispersed in a liquid medium.

Another subject-matter of the invention is a lead battery electrode obtained by using the said composition.

### TECHNICAL FIELD

The present invention relates to the field of lead batteries. More particularly, the present invention relates to the use of a liquid composition for the preparation of lead battery electrode formulations, the liquid composition comprising carbon-based nano fillers, at least one water-soluble polymer and at least one cationic component chosen from alkali metal or alkaline earth metal cations and ammonium ions, dispersed in a liquid medium.

### STATE OF THE ART

Today, lead batteries are the most well-developed rechargeable electrochemical systems due to their high reliability and their low cost, in comparison with systems more recent in development, such as lithium ion batteries. Lead batteries are mainly used to supply the electrical ignition of internal combustion engines, in particular of vehicles, as they are capable of providing a current of high intensity, but they can also be used to store energy intermittently, such as solar or wind energy.

A lead battery is a set of lead/acid elements (or cells) connected in series and combined in one and the same casing. The battery provides electrical energy only if it has been charged beforehand. The elements are in a position to accumulate and to restore the electrical energy by reversible electrochemical reactions occurring during the charging/discharging cycles of the battery.

The performance of a lead battery is essentially evaluated by the maximum current which it can provide in a few moments, by its storage capacity for the available energy and by the number of charging/discharging cycles before complete discharge, which is reflected by a lifetime of the battery.

Typically, in a lead battery, each cell comprises an assembly of electrodes (an anode and a cathode), which are connected with an electrolyte of sulphuric acid type, and the cells are separated from one another by a membrane which can be made of polypropylene, for example.

The anode consists mainly of lead oxide and the cathode of finely distributed spongy lead and they are produced with a current collector generally made of lead or of a lead alloy, such as Pb/Sb or Pb/Ca.

The sulphuric acid, in the dilute aqueous solution or gel form, supplies a stream of sulphate ions between the electrodes. The discharging/charging cycles of the battery are thus reflected by a process of sulphation of the electrodes during the discharging, which is reversible during the charging. However, under certain conditions, the sulphation can generate a stable deposit of lead sulphate on the electrodes, which prevents the electrochemical reactions, in particular the oxidation of the lead during the charging, and thus optimal use of the active material of the electrodes.

The efficacy of the transfer of the sulphate charges between the electrodes and the electrolyte is mainly responsible for the performance and the longevity of the battery.

Various routes have already been explored in the prior art for improving the performances of lead batteries, in particular the addition of carbon-based nanofillers, such as carbon nanotubes, to the active material formulations of the electrodes.

This is because carbon nanotubes (CNTs), consisting of wound graphite sheets, are known for their excellent electrical conductivity and are stable in acidic or corrosive environments. However, CNTs prove to be difficult to handle and to disperse, due to their low size, their dusty nature and, possibly, when they are obtained by chemical vapour deposition (CVD), their entangled structure, furthermore generating strong Van der Waals interactions between their molecules. The weak dispersion of the CNTs in the matrices in which they are incorporated, in particular aqueous electrode formulations, limits their effectiveness and can even affect the transfers of charge between the electrode and the electrolyte and thus the performance of the battery.

In order to overcome the disadvantages related to the incorporation of CNTs in lead battery electrode formulations, the proposal has been made to employ CNTs functionalized by oxygen-comprising groups or by conducting polymers, such as polythiophene, for the purpose of improving their compatibility with the electrode formulation. However, this method, described in the document WO 2013/011516, results in an additional cost related to the nature of the nanofillers added.

The document WO 2012/177869 describes compositions comprising carbon nanotubes intended for improving the performances of lead batteries. The carbon nanotubes are oxidized beforehand and are formulated in an expander in order to prepare electrode active materials.

The document WO 2014/114969 provides a dry route for incorporation of carbon-based nanofillers, in particular crude CNTs, in a pasty electrode formulation which consists in preparing an intimate mixture of CNTs and lead oxide in the powder form using various grinding technologies, for example with a ball mill. This mixture, comprising from 5% to 20% by weight of CNTs in lead oxide, can be used directly in the preparation of an electrode formulation or it can be mixed with lead oxide in order to dope the latter with carbon-based nanofillers. However, this approach is difficult to operate industrially, in view of the large amounts of powder to be coground.

It has also been suggested, in the document WO 2014/141279, to spray a suspension of CNTs in the form of droplets of predetermined size over a matrix comprising lead oxide, in order to homogeneously incorporate CNTs in an electrode formulation. The suspension, with a concentration which can range from 0.005% to approximately 0.1% by weight, is prepared by addition of the CNTs to an aqueous medium under mechanical stirring or under ultrasonic agitation. However, it proves difficult to accurately meter the crude CNTs, which are in the pulverulent state, at this low concentration level.

The document WO 2014/194019 describes the preparation of aqueous dispersions comprising CNTs and a salified water-soluble polymer which can be used in an electrode formulation for an electrochemical cell. There is not the slightest mention of lead battery electrode in this document.

There thus still remains a need to have available a simple, reliable and economical means for homogenously incorporating carbon nanotubes in lead battery electrode formulations.

In point of fact, the Applicant Company has discovered that this need could be met by making available a liquid composition comprising carbon nanotubes dispersed in a liquid medium. The composition, in the liquid state, can be used directly in plants for the production of electrodes for lead batteries.

The document WO 2011/0117530 describes a masterbatch comprising CNTs, a polymer binder, which can be a modified cellulose, and at least one solvent which can be used for the preparation of liquid formulations containing CNTs, in particular in the field of Li-ion batteries. This masterbatch includes from 15% to 40% by weight of CNTs and it is in the agglomerated solid form.

It is apparent, to the Applicant Company, that the combination of a water-soluble polymer and of cations with carbon nanotubes ensures that the liquid composition is stable until it is incorporated in the electrode formulation.

The invention thus provides a liquid composition, stable over time, comprising carbon nanotubes, at least one water-soluble polymer and at least one cationic component chosen from alkali metal or alkaline earth metal cations and ammonium ions which are dispersed in a liquid medium, in particular an aqueous medium, which composition can be used directly to prepare a lead battery electrode formulation.

This composition is ready for use in order to be used easily and in complete safety to prepare formulations for the manufacture of lead battery electrodes, for the purpose of enhancing their electrical performance and improving the overall performances of the lead batteries.

Furthermore, this invention can also be applied to other carbon-based nanofillers and carbon nanotubes and in particular to graphene or a mixture of carbon nanotubes and graphene in all proportions.

### SUMMARY OF THE INVENTION

A subject-matter of the present invention is the use, in the preparation of a lead battery electrode formulation, of a liquid composition, stable over time, comprising from 0.2% to 10% by weight, preferably from 0.2% to 5% by weight, of carbon-based nanofillers, at least one water-soluble polymer and from 0.01% to 50% by weight of at least one cationic component chosen from alkali metal cations or alkaline earth metal cations and ammonium ions dispersed in a liquid medium.

According to the invention, the liquid medium is an aqueous medium.

According to the invention, the carbon-based nanofillers are carbon nanotubes (CNTs), graphene or a mixture of CNTs and graphene in all proportions.

According to the invention, the water-soluble polymer is chosen from polysaccharides; modified polysaccharides, such as modified celluloses; polyethers, such as polyalkylene oxides or polyalkylene glycols; lignosulphonates; polyacrylates; products based on polycarboxylic acids, in particular polyether polycarboxylates or their copolymers; naphthalenesulphonates and their derivatives; and their corresponding aqueous solutions.

The composition in the liquid state, used according to the invention, is stable over time and can be prepared independently of the plant for the production of electrodes for lead batteries.

The term “stable over time” is understood to mean a liquid composition which does not change in physical appearance (no phase separation or appearance of solid particles) or in coloration over time.

The content of carbon-based nanofillers is suitable for direct use of the composition, for example by high pressure spraying, during the preparation of electrode formulations. Alternatively, it can be diluted prior to its use. The consequential dilution maintains good finishing of the dispersion of the carbon-based nanofillers in the liquid medium.

The incorporation of the carbon-based nanofillers in the lead battery electrode formulation using the liquid composition according to the invention creates a better combination of the particles of carbon-based nanofillers with the various active constituents of the formulation, in particular with lead or lead oxide.

The use of the composition as defined according to the invention contributes in addition to limiting the phenomena of corrosion and of cracking of the electrodes which restrict the lifetime of the lead battery.

Another aspect of the invention relates to a lead battery electrode obtained from the said composition, and also to the lead battery comprising at least the said electrode.

The electrode can be an anode or a cathode.

### DETAILED DESCRIPTION OF THE INVENTION

The invention is now described in more detail and without limitation in the description which follows.

The Carbon-Based Nanofillers

The term “carbon-based nanofiller” denotes a carbon-based filler, the smallest dimension of which is between 0.1 and 200 nm, preferably between 0.1 and 160 nm, more preferably between 0.1 and 50 nm, measured by light scattering.

In the continuation of this description, the term “carbon-based nanofillers” denotes carbon nanotubes (CNTs), graphene or a mixture of CNTs and graphene in all proportions.

Preferably, the carbon-based nanofillers are carbon nanotubes.

CNTs have specific crystalline structures, of tubular shape and hollow, obtained from carbon. CNTs generally consist of one or more graphite sheets arranged concentrically around a longitudinal axis. A distinction is thus made between single-walled nanotubes (SWNTs) and multi-walled nanotubes (MWNTs).

Carbon nanotubes usually have a mean diameter ranging from 0.1 to 200 nm, preferably from 0.1 to 100 nm, more preferably from 0.4 to 50 nm and better still from 1 to 30 nm, indeed even from 10 to 15 nm, and advantageously a length of more than 0.1 μm and advantageously from 0.1 to 20 μm, preferably from 0.1 to 10 μm, for example of approximately 6 μm. Their length/diameter ratio is advantageously greater than 10 are generally greater than 100. Their specific surface is, for example, between 100 and 300 m²/g, advantageously between 200 and 300 m²/g, and their bulk density can in particular be between 0.01 and 0.5 g/cm³ and more preferably between 0.07 and 0.2 g/cm³. Multi-walled carbon nanotubes can, for example, comprise from 5 to 15 sheets and more preferably from 7 to 10 sheets.

CNTs can be produced according to different processes; however, the CNTs participating in the composition according to the invention are preferably synthesized by chemical vapour deposition (CVD) as this process is the most suitable for industrial manufacture in terms of quality of the CNTs.

An example of such crude carbon nanotubes is in particular the trade name Graphistrength® C100 from Arkema.

These nanotubes can be purified and/or treated (for example oxidized) and/or ground.

The grinding of the nanotubes can in particular be carried out under cold conditions or under hot conditions and can be carried out according to the known techniques employed in devices such as ball, hammer, edge runner, knife or gas jet mills or any other grinding system capable of reducing the size of the entangled network of nanotubes. It is preferable for this grinding stage to be carried out according to a gas jet grinding technique and in particular in an air jet mill.

The crude or ground nanotubes can be purified by washing using a sulphuric acid solution, so as to free them from possible residual inorganic and metallic impurities, such as, for example, iron, originating from their preparation process. The ratio by weight of the nanotubes for the sulphuric acid can in particular be between 1:2 and 1:3. The purification operation can furthermore be carried out at a temperature ranging from 90 to 120° C., for example for a period of time of 5 to 10 hours. This operation can advantageously be followed by stages in which the purified nanotubes are rinsed with water and dried. In an alternative form, the nanotubes can be purified by a high-temperature heat treatment, typically at greater than 1000° C.

The oxidation of the nanotubes is advantageously carried out by bringing the latter into contact with a sodium hypochlorite solution including from 0.5% to 15% by weight of NaOCl and preferably from 1% to 10% by weight of NaOCl, for example in a ratio by weight of the nanotubes to the sodium hypochlorite ranging from 1:0.1 to 1:1. The oxidation is advantageously carried out at a temperature of less than 60° C. and preferably at ambient temperature, for a period of time ranging from a few minutes to 24 hours. This oxidation operation can advantageously be followed by stages in which the oxidized nanotubes are filtered and/or centrifuged, washed and dried.

Use is preferably made, in the present invention, of crude carbon nanotubes, that is to say nanotubes which are neither oxidized nor purified nor functionalized and which have not been subjected to any other chemical and/or heat and/or mechanical treatment, which are optionally ground.

Furthermore, it is preferable to use carbon nanotubes obtained from renewable starting material, in particular of vegetable origin, as described in Application FR 2 914 634.

The graphene which can participate in the composition according to the invention is obtained by chemical vapour deposition or CVD, preferably according to a process using a pulverulent catalyst based on a mixed oxide. It is characteristically provided in the form of particles having a thickness of less than 50 nm, preferably of less than 15 nm and more preferentially of less than 5 nm, and having lateral dimensions of less than a micron, preferably from 10 nm to less than 1000 nm, more preferably from 50 to 600 nm, indeed even from 100 to 400 nm. Each of these particles generally includes from 1 to 50 sheets, preferably from 1 to 20 sheets and more preferably from 1 to 10 sheets, indeed even from 1 to 5 sheets, which are capable of being separated from one another in the form of independent sheets, for example during a treatment with ultrasound.

The Water-Soluble Polymer

The water-soluble polymer can be ionic or nonionic.

Use is made, in the present invention, as water-soluble polymers, without this list being limiting, of polysaccharides; modified polysaccharides, such as modified celluloses; polyethers, such as polyalkylene oxides or polyalkylene glycols; lignosulphonates; polyacrylates; products based on polycarboxylic acids, in particular polyether polycarboxylates or their copolymers; naphthalenesulphonates and their derivatives; and their corresponding aqueous solutions.

Use may be made of several water-soluble polymers in the form of a mixture in all proportions.

Preferably, the water-soluble polymer is chosen from modified celluloses, in particular carboxymethylcellulose (CMC), lignosulphonates, polyether polycarboxylates or their copolymers, naphthalenesulphonates and their derivatives, and their corresponding aqueous solutions.

Use may be made, for example, of the commercial products of the Ethacryl® range or the product XP 1824 from Coatex.

The water-soluble polymers are generally commercially available in the solid form or in the form of an aqueous solution having a more or less high viscosity.

The Cationic Components

The presence of a cationic component, in particular of at least one cation of an alkali metal or alkaline earth metal or ammonium ion, in the liquid composition according to the invention contributes to ensuring the stabilization of the dispersion of the carbon-based nanofillers. In addition, it makes it possible to limit the problems of corrosion in the electrode formulation.

Alkali metal or alkaline earth metal cations are preferred as cationic component.

Mention may be made, as cations, for example, of Na⁺, K⁺, Mg²⁺, Ca²⁺ or Ba²⁺, used alone or as a mixture; preferably, the cations are Na⁺.

The cationic components are present in the composition according to the invention generally by introduction of a base in aqueous solution or they can be contributed at least partly by the water-soluble polymer when the latter is in a salified form.

The Liquid Composition

The term “liquid composition” is understood to mean that the composition exhibits a viscosity capable of being sprayed using any device of the state of the art. In particular, the composition according to the invention advantageously exhibits a dynamic viscosity ranging from 10⁻³ to 3×10³ Pa·s, preferably from 2×10⁻³ to 10 Pa·s, measured by a capillary viscometer or by the Brookfield method, at ambient temperature (23° C.). If it cannot be sprayed directly, the liquid composition can be diluted beforehand so as to confer the appropriate viscosity on it.

The liquid composition used according to the invention is stable over time and can be stored for its subsequent use without a change in physical appearance becoming apparent. The stability can be easily checked, for example by measuring the stability of the viscosity over time or by carrying out visual monitoring of the absence of solid particles.

The liquid composition used according to the invention comprises from 0.2% to 10% by weight, preferably from 0.2% to 5% by weight, of carbon-based nanofillers, with respect to the total weight of the composition.

According to one embodiment of the invention, the carbon-based nanofillers represent from 0.2% to 3% by weight, with respect to the total weight of the composition.

According to one embodiment of the invention, the liquid composition comprises from 0.05% to 50% by weight of cationic component, preferably from 0.05% to 5% more preferably from 0.05% to 2% by weight of cationic component, with respect to the total weight of the composition.

According to another embodiment of the invention, the liquid composition comprises from 0.01% to 5% by weight of cationic component, preferably from 0.01% to 2% by weight of cationic component, with respect to the total weight of the composition.

According to one embodiment of the invention, the water-soluble polymer represents from 0.1% to 60% by weight, preferably from 0.1% to 50% by weight and more preferably from 0.1% to 30% by weight, with respect to the total weight of the composition.

According to the invention, the liquid medium is the continuous aqueous phase in which the carbon-based nanofillers, the water-soluble polymer and the cations are homogeneously dispersed, that is to say the aqueous medium in which the composition used according to the invention is prepared. The solids represent of the order of 0.3% to 40%, preferably from 0.5% to 30% by weight of the liquid composition.

According to one embodiment, the liquid medium comprises water and a water-soluble organic solvent.

According to another embodiment, the liquid medium comprises water and an inorganic acid, in particular sulphuric acid.

Preferably, the liquid medium is water.

The liquid composition used according to the invention can be prepared in different ways.

In particular, the liquid composition can be prepared from a solid composition comprising carbon-based nanofillers dispersed in at least one water-soluble polymer in the presence of at least one cationic component.

In an alternative form, the liquid composition can be prepared directly from carbon-based nanofillers in the solid state.

According to a first aspect, the liquid composition is prepared by introduction of a composition comprising carbon-based nanofillers, at least one water-soluble polymer and at least one cationic component chosen from alkali metal or alkaline earth metal cations and ammonium ions, in the solid state, into an aqueous medium and then mixing with stirring, so as to obtain efficient dispersion of the constituents of the solid composition in the aqueous medium.

The said solid composition advantageously comprises from 5% to 60% of carbon-based nanofillers, preferably from 18% to 50% by weight, indeed even from 40% to 50% by weight, of carbon-based nanofillers, with respect to the total weight of the solid composition.

The amount of solid composition introduced into the aqueous medium is adjusted so as to obtain the desired content of carbon-based nanofillers in the liquid composition.

The introduction into the aqueous medium can be carried out gradually or intermittently.

The aqueous medium can be heated at a temperature ranging from 40° C. to 90° C.

The mixture is advantageously carried out under moderate stirring in a mixer, such as a disc mixer, for example at a speed of 3000 rpm, for a period of time which can range from one hour to several hours.

According to a second aspect, the liquid composition is prepared by introduction of carbon-based nanofillers in the solid state into a liquid base comprising an aqueous medium, at least one water-soluble polymer and at least one cationic component chosen from alkali metal or alkaline earth metal cations and ammonium ions and then mixing, so as to obtain efficient dispersion of the carbon-based nanofillers in the liquid base.

The liquid base can be obtained by mixing a water-soluble polymer and cationic component in the aqueous medium.

The aqueous medium or the liquid base can be heated at a temperature ranging from ambient temperature to 50° C.

The mixing of the carbon-based nanofillers and of the liquid base can be carried out in any mixer, such as disc mixers, blade mixers, planetary mixers, screw mixers, bead mills, triple roll mills, and the like.

Use is advantageously made of a disc mixer, at a speed of at least 500 rpm and for a period time of at least one hour, until a homogenous liquid is obtained.

According to an embodiment, the liquid composition obtained is finally subjected to grinding, for example in a bead mill, so as to obtain a composition in the liquid state not comprising aggregates with a size greater than 5 μm (measured by the North bar).

The dispersion of the carbon-based nanofillers in the presence of the water-soluble polymer and of the cationic components is thus efficient and homogeneous in the aqueous medium.

Use of the Composition

The liquid composition is used according to the invention to homogeneously incorporate carbon-based nanofillers in a pasty composition intended to cover a solid current collector in order to form a lead battery electrode, which can be an anode or a cathode. The incorporation of the carbon-based nanofillers is facilitated owing to the fact that they are present in a composition in the liquid state and that they exhibit a hydrophilic nature compatible with the aqueous formulations of the electrodes due to their combination with a water-soluble polymer.

The lead battery electrode formulation, generally in the form of a pasty composition, generally comprises lead oxide, water, sulphuric acid, mechanical reinforcing fillers, such as glass fibres, carbon fibres or polyester fibres, and various compounds including barium sulphate or carbon black, or other electroactive compounds.

The lead oxide is understood to mean a mixture of lead oxides of formula PbOₓ with 1≦x≦2, with the possible presence of nonoxidized lead.

According to one embodiment of the invention, the liquid composition is sprayed under high pressure over a matrix comprising lead oxide in the solid form or in the paste form, during the preparation of the electrode formulation.

Use may be made, as device for spraying the liquid composition, of a system composed of a pump which generates a pressure and of a pipe connecting the pump and a nozzle which forms a spray.

According to an embodiment, the liquid composition according to the invention is diluted beforehand in water before being sprayed under high pressure over a matrix comprising lead oxide in the solid form or in the paste form. The liquid composition according to the invention can thus be advantageously used to prepare CNT suspensions with a concentration which can range from 0.005% to approximately 0.1% by weight, which suspensions are sprayed in the form of droplets of predetermined size over a matrix comprising lead oxide under the conditions described in the document WO 2014/141279.

The mixing of the constituents of the electrode formulation in order to form the paste can be carried out in any type of compounding device, such as a blade mixer, a planetary mixer, a screw mixer, and the like.

The proportions of the various compounds used in the electrode formulation are adjusted so that the amount of carbon-based nanofillers advantageously varies from 0.0005% to 1% by weight, with respect to the weight of the formulation, preferably from 0.001% to 0.5% by weight, and preferably from 0.001% to 0.01% by weight, with respect to the weight of the formulation.

The sulphuric acid can be present at a concentration ranging from 1 to 20 mol/l and preferably between 3 and 5 mol/l. The sulphuric acid can represent from 1% to 10%, preferably from 2% to 7%, of the total weight of the formulation.

The amount of water present in the pasty composition is between 7% and 20% by weight, with respect to the weight of the pasty composition.

The mechanical reinforcing fillers, preferably glass fibres, are present at a content ranging from 0.1% to 1% by weight, with respect to the weight of the pasty composition.

The invention also relates to a lead battery electrode obtained from a liquid composition, stable over time, comprising from 0.2% to 10% by weight of carbon-based nanofillers, at least one water-soluble polymer and at least one cationic component chosen from alkali metal or alkaline earth metal cations and ammonium ions dispersed in an aqueous medium, as defined above.

A process for the preparation of a lead battery electrode can comprise, for example, at least the following stages:
a) making available a liquid composition as described above;
b) preparing a pasty composition comprising the use of the said liquid composition;
c) impregnating a grid using the pasty composition of stage b);
d) pressing, followed by drying and maturing the impregnated grid.

It is clearly understood that the above process can comprise other preliminary, intermediate or subsequent stages, provided that they do not have a negative effect on the obtaining of the desired electrode.

The grid can be flexible or rigid or be provided in different forms. The grid is composed of lead or of a lead-based alloy.

After the application of the paste to the grid, drying is generally carried out at a temperature ranging from 30° C. to 65° C., under at least 80% relative humidity, for more than 18 hours. Maturing is then preferably carried out, for example from 55 to 80° C. under ambient relative humidity, for one to three days.

The electrode according to the invention can be an anode or a cathode.

Another subject-matter of the invention is a lead battery comprising at least one electrode according to the invention.

A lead battery generally comprises a separator between each pair of positive and negative electrodes. This separator can be any porous nonconducting material, for example a sheet of polypropylene or of polyethylene. Its thickness can vary from 0.01 to 0.1 mm. A pair of electrodes and a separator define a cell. The lead battery of the present invention can comprise from 1 to 12 cells, which can provide a voltage at each of 1.5 to 2.5 volts.

The incorporation of the carbon-based nanofillers using the composition described in the invention makes it possible to improve the number of charging/discharging cycles of the battery and thus to prolong the operation life of the battery.

The invention will now be illustrated by the following examples, which do not have the aim of limiting the scope of the invention, defined by the appended claims.

### EXPERIMENTAL PART

### Example 1: Preparation of a Liquid Composition from a Solid CNT/CMC Composition

The solid Graphistrength® CW2-45 masterbatch, comprising, by weight, 45% of CNTs, 53% of CMC and 2% of Na⁺, was introduced into hot water at 60° C. under moderate stirring, so as to obtain a CNT concentration of 2% by weight in the aqueous composition.

Stirring was maintained for one hour, which resulted in a gradual cooling of the dispersion.

Under these conditions, efficient dispersion of the carbon nanotubes in the water was obtained.

The dispersion, with a Brookfield viscosity of 40 mPa·s, measured at 23° C., is stable over time and can be used in a lead battery electrode formulation.

Depending on the equipment available, the liquid composition is sprayed as is, or after dilution down to a concentration of 0.2% by weight of CNTs, under high pressure over lead oxide at the same time as the introduction of other liquids, in particular of water and sulphuric acid, into the mixer used to prepare the electrode formulation.

### Example 2: Preparation of a Liquid Composition from Crude CNTs

A polyether polycarboxylate (PCE) in aqueous solution (Ethacryl® HF grade, produced by Coatex) was diluted with demineralized water (75% Ethacryl, 25% water). The aqueous solution, containing 30% by weight of PCE, was neutralized with 1% of NaOH.

Powdered CNTs (Graphistrength® C100 grade) were introduced into this liquid base. Mixing was carried out with a disc mixer at 400 rpm for 2 hours.

This homogenized mixture was subsequently subjected to grinding in a bead mill (ZrOx beads, diameter 1 mm) until the aggregates with a size of greater than 5 μm had disappeared (monitored with the North bar).

The liquid composition contains, by weight, 2.5% of CNTs, 26.5% of PCE and 1% of NaOH.

It can be used to prepare a lead battery electrode formulation.

### Example 3: Monitoring of the Stability Over Time of a Liquid Composition Comprising 2% by Weight of CNTs

A novel liquid composition comprising 2% by weight of CNTs was prepared under the conditions described in Example 1.

The composition was maintained at ambient temperature for 35 days.

The Brookfield viscosity was monitored over time (Brookfield viscosity of the water with spindle 1 at 50 rpm=8 cP).

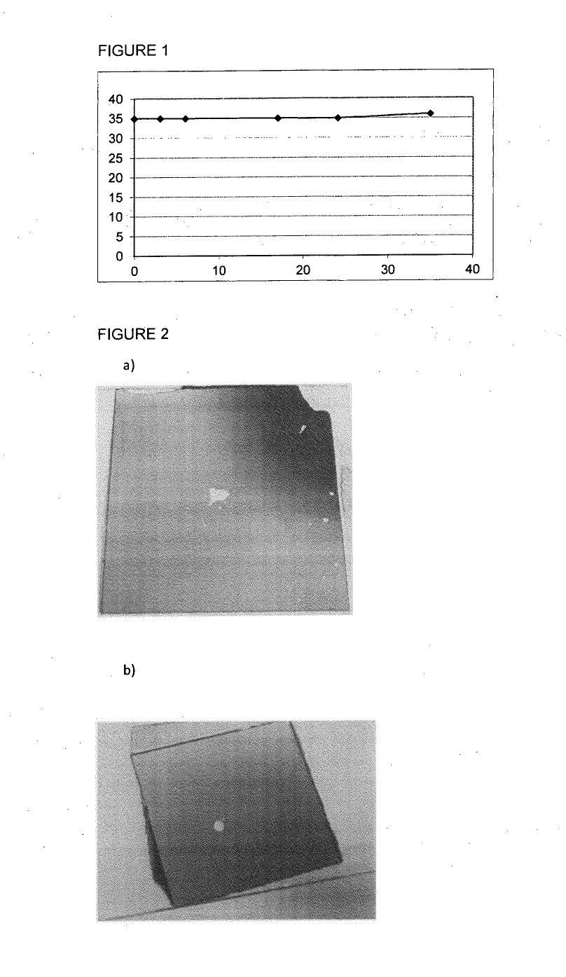

The representation of the viscosity in cP of the composition over time (in days) in FIG. 1 confirms that there is no change in the viscosity during the storage of the composition.

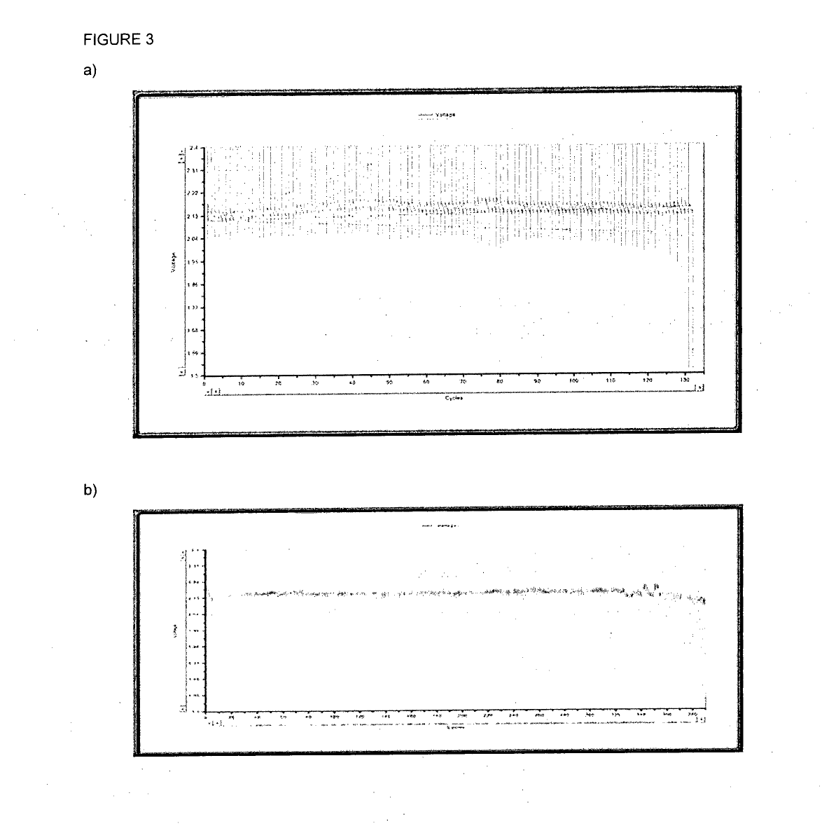

The absence of appearance of solid particles was displayed by monitoring, by eye, the composition placed between 2 slides at t=0 and t=35 days, as represented in FIGS. 2a) and 2b) respectively.

### Example 4: CNT Dispersion Quality and a Cycle Life of Lead Acid Battery

Two types of CNT dispersions have been used to modify the lead oxide electrode paste in a full battery cell.
Dispersion 1. 0.2% CNT dispersion prepared as described in Example 1
Dispersion 2. 0.2% CNT dispersion stabilized with the same ratio of CMC, prepared directly in high share mixer

Charge Discharge Cycles have been processed with 25% of discharge ratio till the cell is failed. Cycle life number represent average value from 5 cells.

| | | Number |
|---|---|---|
| | | of Cycles |
| Test no | Active material | till failure |
| 1 (Reference) | Lead Oxide paste without additives | 131 |
| 2 (Comparative) | 0.1% CNT to Lead Oxide, | 193 |
| | Dispersion 2 | |
| 3 (According to | 0.1% CNT to Lead Oxide, | 387 |
| the invention) | Dispersion 1 | |

FIGS. 3 a) and b) represent respectively the battery performance evolution for the reference cell and the cells improved with good CNT dispersion described in Example 1.

As a conclusion, the CNT presence in low quantity correctly introduced in Lead Oxide active material leads to improved cycle life of the battery. The dispersion quality is the key issue for appropriate modification of the lead oxide, resulting in the optimal improvement of the battery performance.

1-13. (canceled)

14. A lead battery electrode formulation comprising a liquid composition, which is stable over time, the composition comprising
from 0.2% to 10% by weight of carbon-based nanofillers, wherein the carbon-based nanofillers comprise carbon nanotubes, graphene or a mixture of carbon nanotubes and graphene in all proportions;
at least one water-soluble polymer, wherein the water-soluble polymer comprises polysaccharides, modified polysaccharides, polyethers, lignosulphonates, polyacrylates, products based on polycarboxylic acids, naphthalenesulphonates and their derivatives, and their corresponding aqueous solutions; and
from 0.01% to 50% by weight of at least one cationic component comprising alkali metal or alkaline earth metal cations and ammonium ions dispersed in an aqueous medium.

15. The formulation of claim 14, wherein the composition comprises from 0.2% to 5% by weight of carbon-based nanofillers.

16. The formulation of claim 14, wherein the water-soluble polymer comprises modified celluloses, lignosulphonates, polyether polycarboxylates or their copolymers, naphthalenesulphonates and their derivatives, or their corresponding aqueous solutions.

17. The formulation of claim 14, wherein the water-soluble polymer represents from 0.1% to 60% by weight, with respect to the total weight of the composition.

18. The formulation of claim 14, wherein the composition comprises from 0.01% to 5% by weight of the at least one cationic component, with respect to the total weight of the composition.

19. The formulation of claim 14, wherein a solids content of the composition represents from 0.3% to 40% of the weight of the composition.

20. The formulation of claim 14, wherein the aqueous medium comprises water, water and a water-soluble organic solvent, or water and an inorganic acid.

21. Method for producing a liquid composition, which is stable over time, and which is used in the preparation of the lead battery electrode formulation of claim 14, the method comprising
introducing a composition comprising carbon-based nanofillers, at least one water-soluble polymer and at least one cationic component, wherein the at least one cationic component comprises alkali metal or alkaline earth metal cations and ammonium ions, in the solid state, into an aqueous medium, and
mixing the composition comprising carbon-based nanofillers, the at least one water-soluble polymer and the at least one cationic component with stirring, so as to obtain efficient dispersion thereof in the aqueous medium.

22. Method for producing a liquid composition, which is stable over time, and which is used in the preparation of the lead battery electrode formulation of claim 14, the method comprising
introducing carbon-based nanofillers in the solid state into a liquid base comprising an aqueous medium, at least one water-soluble polymer and at least one cationic component, wherein the at least one cationic component comprises alkali metal or alkaline earth metal cations and ammonium ions, and
mixing, so as to obtain efficient dispersion of the carbon-based nanofillers in the liquid base.

23. The electrode formulation of claim 14, wherein the electrode is an anode.

24. The electrode formulation of claim 14, wherein the electrode is a cathode.

25. A lead battery comprising the electrode formulation of claim 14.
